(19) United States
(12) Patent Application Publication
(10) Pub. No.: US 2025/0363588 A1
(43) Pub. Date: Nov. 27, 2025

(54) INFORMATION PROCESSING DEVICE, INFORMATION PROCESSING METHOD, AND PROGRAM

(71) Applicant: SONY GROUP CORPORATION, Tokyo (JP)

(72) Inventors: Atsushi ISHIHARA, Tokyo (JP); Hiroyuki AGA, Tokyo (JP); Koichi KAWASAKI, Tokyo (JP)

(21) Appl. No.: 18/873,706

(22) PCT Filed: May 19, 2023
(86) PCT No.: PCT/JP2023/018711

§ 371 Date: Dec. 10, 2024

(30) Foreign Application Priority Data
Jun. 15, 2022 (JP) 2022-096820

(51) Int. Cl. G06T 3/18; G02B 27/01; G06T 7/70

(52) U.S. Cl. CPC G06T 3/18; G02B 27/0172; G06T 7/70

(57) ABSTRACT

An information processing device includes: an own position/posture estimation unit that estimates a position and a posture of a device based on sensing information acquired by a sensor unit, and outputs own position/posture information; and an image deformation unit that performs deformation processing on an image based on the own position/posture information and distortion of an optical system included in the device.

### TECHNICAL FIELD

The present technology relates to an information processing device, an information processing method, and a program.

### BACKGROUND ART

There are Head Mount Displays (HMDs) for Virtual Reality (VR) and Augmented Reality (AR).

Such an HMD for VR or for AR (hereinafter, described as an XR HMD) estimates an own position/posture of a user using an image sensor, an inertial sensor, or the like, and draws a virtual object at a place intended in consideration of the own position/posture. The user can see an image that is a drawing result of the virtual object through a display and or the like included in the XR HMD. When a processing time from estimation to display of a motion becomes long, delay occurs until the virtual object is displayed at an expected position (delay occurs), and, as a result, not only does not make the user feel that the virtual object is at the expected place, but also causes sickness. There is widely known a method (that is referred to as time warp or temporal reprojection) of the XR HMD for estimating again an own position/posture of a user immediately before displaying a drawing result, and performing image deformation on the drawing result based on an estimation result such that delay does not seemingly occur. Image deformation refers to an action of mapping on another set an element set constituting an image. A method that includes such image deformation and solves delay of display will be referred to as delay compensation. Note that the element set may be a pixel or may be an apex. Image deformation in a broad sense not only is performed for the purpose of delay compensation, but also includes display distortion correction.

There is proposed a technology of estimating an own position/posture more frequently than an update frequency of a display unit using an inertia sensor, and performing image deformation a plurality of times on a scan type display that causes pixels to emit light from the top of a screen (PTL 1).

### CITATION LIST

### Patent Literature

### [PTL 1]

JP 2021-105749A

### SUMMARY

### Technical Problem

The technology according to PTL 1 can correct an image closer to a true value since the image having the own position/posture calculated immediately before is deformed a larger number of times compared to a case where the image is corrected only once immediately before display. However, there is a problem that, when distortion of an optical system such as a display is corrected after or at the same time as image deformation for delay compensation, a light emission time difference between pixels caused by the distortion of the optical system is not taken into account, and therefore an expected correction result is hardly obtained as the distortion of the optical system is greater, and an image displayed on the display is distorted.

With such a problem in view, it is an object of the present technology to provide an information processing device, an information processing method, and a program that can display an image without distorting the image.

### Solution to Problem

To solve the above-described problem, a first technology is an information processing device that includes: an own position/posture estimation unit that estimates a position and a posture of a device based on sensing information acquired by a sensor unit, and outputs own position/posture information; and an image deformation unit that performs deformation processing on an image based on the own position/posture information and information related to distortion of an optical system included in the device.

Furthermore, a second technology is an information processing method that includes: estimating a position and a posture of a device based on sensing information acquired by a sensor unit, and outputting own position/posture information; and performing deformation processing on an image based on the own position/posture information and information related to distortion of an optical system included in the device.

Furthermore, a third technology is a program that causes a computer to execute an information processing method including: estimating a position and a posture of a device based on sensing information acquired by a sensor unit, and outputting own position/posture information; and performing deformation processing on an image based on the own position/posture information and information related to distortion of an optical system included in the device.

### BRIEF DESCRIPTION OF DRAWINGS

FIG. 1A is an external appearance perspective view of an HMD 10 according to a first embodiment, and FIG. 1B is an internal view of a housing 20 of the HMD 10.

FIG. 2 is a block diagram illustrating configurations of the HMD 10 and an information processing device 100 according to the first embodiment.

FIG. 3 is an explanatory view of definitions of symbols.

FIG. 4 is an explanatory view of distortion of a display 16 and distortion correction.

FIG. 5 is an explanatory view of image deformation in a case where the HMD 10 stops.

FIG. 6 is an explanatory view of a problem of image deformation in a case where the HMD 10 is moving.

FIG. 7 is an explanatory view of light emission of a pixel of a scan type display.

FIG. 8 is an explanatory view of image deformation according to the first embodiment.

FIG. 9 is an explanatory view of a light emission time correction map.

FIG. 10 is a flowchart illustrating processing in the HMD 10 and the information processing device 100 according to the first embodiment.

FIG. 11 is an explanatory view of a problem of rolling shutter distortion correction.

FIG. 12A is an external appearance perspective view of the HMD 10 according to a second embodiment, and FIG. 12B is an internal view of the housing 20 of the HMD 10.

FIG. 13 is a block diagram illustrating configurations of the HMD 10 and the information processing device 100 according to the second embodiment.

FIG. 14 is an explanatory view of image deformation according to the second embodiment.

FIG. 15 is an explanatory view of image deformation according to the second embodiment.

FIG. 16 is a flowchart illustrating processing in the HMD 10 and the information processing device 100 according to the second embodiment.

FIG. 17 is a flowchart illustrating processing in the HMD 10 and the information processing device 100 according to the second embodiment.

FIG. 18 is an explanatory view of forward mapping and inverse mapping.

FIG. 19 is an explanatory view of image deformation that uses forward mapping according to a modification of the present technology.

FIG. 20 is an explanatory view of image deformation that uses inverse mapping according to the modification of the present technology.

### DESCRIPTION OF EMBODIMENTS

Hereinafter, embodiments of the present technology will be described with reference to the drawings. Hereinafter, descriptions will proceed in the following order.
<1. First Embodiment>
[1-1. Configurations of HMD 10 And Information Processing Device 100]
[1-2. Definitions of Symbols]
[1-3. Distortion Correction Processing]
[1-4. Processing in HMD 10 and Information Processing Device 100]
<2. Second Embodiment>
[2-1. Shutter System of Camera and Distortion Correction Processing]
[2-2. Configurations of HMD 10 And Information Processing Device 100]
[2-3. Processing in HMD 10 and Information Processing Device 100]
<3. Modification>

### 1. First Embodiment

### 1-1. Configurations of HMD 10 And Information Processing Device 100

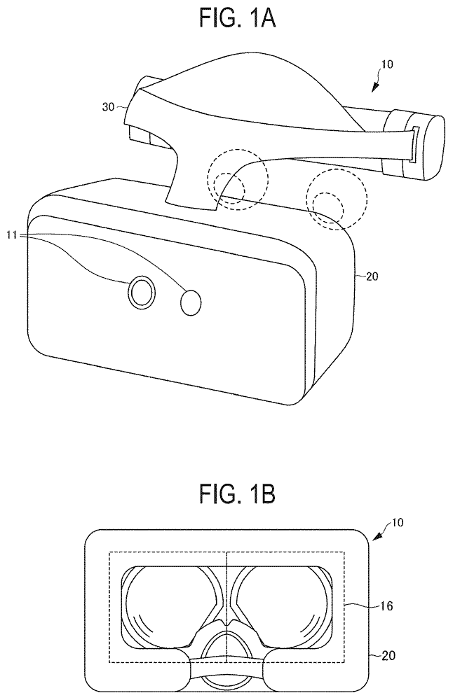

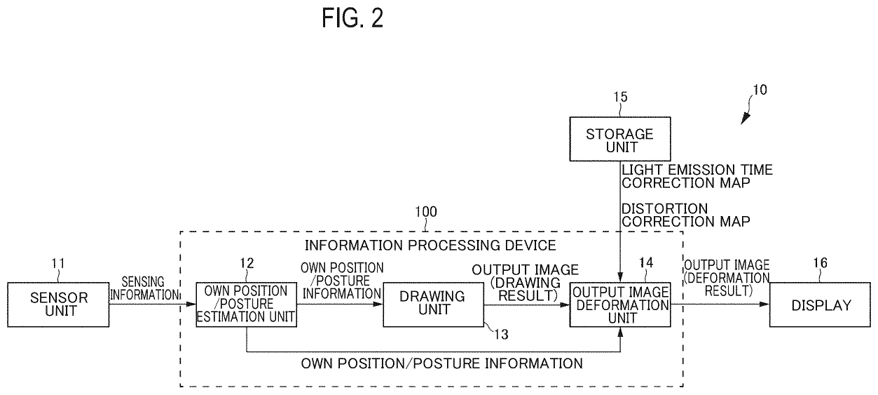

Configurations of the HMD 10 that has a VST function and the information processing device 100 will be described with reference to FIGS. 1 and 2.

The HMD 10 is an XR HMD that a user is equipped with. As illustrated in FIG. 1, the HMD 10 includes a housing 20 and a band 30. Inside the housing 20, a display 16, a circuit board, a processor, a battery, an input/output port, and the like are accommodated. Furthermore, an image sensor, various sensors, and the like that are a sensor unit 11 are provided on a front surface of the housing 20.

As illustrated in FIG. 2, the HMD 10 includes the sensor unit 11, an own position/posture estimation unit 12, a drawing unit 13, an output image deformation unit 14, a storage unit 15, and the display 16. The HMD 10 corresponds to a device in the claims.

The sensor unit 11 includes the various sensors that detect sensing information for estimating an own position/posture of the HMD 10. The sensor unit 11 outputs the sensing information to the own position/posture estimation unit 12. The sensor unit 11 includes, for example, an image sensor for photographing a real world, a Global Positioning System (GPS) for acquiring position information, an Inertial Measurement Unit (IMU), and an ultrasonic sensor, and, moreover, inertial sensors (an acceleration sensor, an angular velocity sensor, and a gyro sensor with respect to two-axis or three-axis directions) for improving estimation accuracy and reducing delay of a system. A plurality of sensors may be used in combination as the sensor unit 11. Note that, when own position/posture estimation is 3 Degrees of Freedom (DoF) instead of 6 DoF, the sensor unit 11 may be only a gyro sensor. Furthermore, the image sensor does not necessarily need to be mounted on the HMD 10, and may be an outside-in camera.

The own position/posture estimation unit 12 estimates a position and a posture of the HMD 10 based on the sensing information output from the sensor unit 11. By estimating the position and the posture of the HMD 10, the own position/posture estimation unit 12 can also estimate a position and a posture of a head of the user who is equipped with the HMD 10. Note that the own position/posture estimation unit 12 can also estimate a motion, an inclination, and the like of the HMD 10 based on the sensing information output from the sensor unit 11. The own position/posture estimation unit 12 outputs own position/posture information that is an estimation result to the drawing unit 13 and the output image deformation unit 14.

The own position/posture estimation unit 12 can estimate the position and the posture by using an algorithm of estimating rotation of the user's head using an angular acceleration acquired from the gyro sensor in a case of 3 DoF.

Furthermore, in a case of 6 DoF, it is possible to estimate the own position/posture of the HMD 10 in a world coordinate system by a technique such as Simultaneous Localization And Mapping (SLAM), Visual Odometry (VO), or Visual Inertial Odometry (VIO) using an image captured by the image sensor that is the sensor unit 11. According to VIO, it is generally assumed to estimate an own position/posture by a technique such as an Inertial Navigation System (INS) using an output of the inertial sensor whose output rate is high compared to the image sensor. These estimation processing is usually performed in a general Central Processing Unit (CPU) or Graphics Processing Unit (GPU), yet may be performed by a processor specialized in image processing or machine learning processing.

The drawing unit 13 draws a virtual object based on the own position/posture information using a 3D Computer Graphic (CG) technique, and generates an output image to be displayed on the display 16. A time required for drawing processing depends on drawing contents and virtual objects are not displayed in order from a drawn virtual object, and therefore there is widely adopted a system (a double buffering system or a triple buffering system) that generally uses a plurality of frame buffers and replaces the plurality of frame buffers at a display update timing when drawing is completed. Although a GPU is usually used for drawing, a CPU may be used to perform drawing.

The output image deformation unit 14 performs deformation processing on an output image that is a drawing result based on a light emission time correction map, a distortion correction map, and the own position/posture information that are information related to distortion of the display 16. The deformation processing includes delay compensation processing, conversion processing of a delay compensation result, and distortion correction processing. Processing in the output image deformation unit 14 may be performed by a general-purpose processor such as a GPU, or a dedicated circuit.

The HMD 10 draws a virtual object at an intended place based on the own position/posture information, and generates the output image, and the user sees this virtual object by seeing the output image displayed on the display 16. When a processing time from estimation of the own position/posture to display on the display 16 becomes long, displaying the virtual object at an appropriate position is delayed. The delay compensation processing is deformation processing for compensating for delay of display of the output image on this display 16.

As an image deformation method that is the delay compensation processing, there is widely known a method (time warp or temporal reprojection) for estimating again an own position/posture of a user immediately before an output image that is a drawing result is displayed, and deforms the output image based on an estimation result such that delay does not seemingly occur. Image deformation refers to an action of mapping on another set an element set constituting an image. Any method can be adopted as long as methods including such image deformation compensate for delay of display.

Conversion processing of the delay compensation result is conversion processing for making a delay compensation result that is a result obtained by performing delay compensation processing on an output image, and a display result of an output image of the display 16 identical even when distortion of the display 16 is great.

Distortion correction processing is deformation processing of applying, to an output image, distortion opposite to distortion of the display 16 to display the output image in a state without distortion on the display 16 having the distortion.

The storage unit 15 is, for example, a large-capacity storage medium such as a hard disk or a Solid State Drive (SSD). In the storage unit 15, various applications that operate on the HMD 10, the light emission time correction map, the distortion correction map, other various pieces of information, and the like that are used by the information processing device 100 are stored. Note that the light emission time correction map and the distortion correction map may be acquired not from the storage unit 15, but from an external device or an external server via a network. The light emission time correction map and the distortion correction map may be created in advance, for example, at a time of manufacturing of the HMD 10 or before use of the HMD 10, and is stored in the storage unit 15.

The display 16 is a display device that displays an output image that is a deformation result output from the output image deformation unit 14. The display 16 may be a scan type display device such as a Liquid Crystal Display (LCD) panel or an organic Electro Luminescence (EL) panel. As indicated by a broken line in FIG. 1B, the display 16 is supported such that the display 16 is located inside the housing 20 and in front of the user's eyes at the time of equipment of the HMD 10. Note that the display 16 may include a left display that displays a left-eye image, and a right display that displays a right-eye image.

Although not illustrated, the HMD 10 also includes a control unit, an interface, and the like. The control unit includes a CPU, a Random Access Memory (RAM), a Read Only Memory (ROM), and the like. The CPU controls all or each of units of the HMD 10 by executing various processing and issuing commands according to the programs stored in the ROM.

The interface is an interface between an external electronic device such as a personal computer or a game machine, and the Internet. The interface may include a wire or wireless communication interface. More specifically, the wire or wireless communication interface may include cellular communication, Wi-Fi, Bluetooth (registered trademark), Near Field Communication (NFC), the Ethernet (registered trademark), a High-Definition Multimedia Interface (registered trademark), (HDMI), a Universal Serial Bus (USB), and the like.

The information processing device 100 includes the own position/posture estimation unit 12, the drawing unit 13, and the output image deformation unit 14. Note that the information processing device 100 may operate in the HMD 10, may operate in an external electronic device such as a personal computer, a game machine, a tablet terminal, or a smartphone connected with the HMD 10, or may be configured as a single device connected with the HMD 10. Furthermore, by executing a program in the HMD 10 and the external electronic device that have functions as computers, the information processing device 100 and an information processing method may be implemented. When the information processing device 100 is implemented by executing a program, the program may be installed in advance in the HMD 10 or the electronic device, or may be downloaded and distributed with a storage medium or the like, and the user may install the program by oneself.

When the information processing device 100 operates in the external electronic device, the sensing information acquired by the sensor unit 11 is transmitted to the external electronic device via the interface and the network (a wired network or a wireless network does not matter). Furthermore, an output from the output image deformation unit 14 is transmitted to the HMD 10 via the interface and the network, and is displayed on the display 16.

Furthermore, the sensor unit 11 may not be included in the HMD 10, and the sensor unit 11 may be configured to be connected to the HMD 10 as a device different from the HMD 10.

Furthermore, the HMD 10 may be configured as a wearable device such as an eyeglass type that does not include the band 30, or may be configured integrally with a headphone or an earphone. Furthermore, the HMD 10 may not only be configured as an integrated-type HMD, but also be configured by fitting an electronic device such as a smartphone or a tablet terminal to a band-like attachment tool to support.

### 1-2. Definitions of Symbols

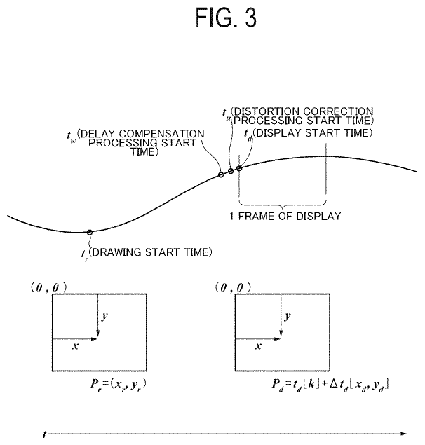

Next, definitions of symbols used to describe the information processing device 100 will be described with reference to FIG. 3. t represents a time. tᵣ represents a drawing start time of the drawing unit 13. t_{W} represents a start time of delay compensation processing of the output image deformation unit 14. tᵤ represents a start time of distortion correction processing of the output image deformation unit 14. t_{d} represents a display start time of an output image of the display 16. The display start time may be also referred to as a scan start time of pixels or a light emission start time of pixels in the display 16.

P represents coordinates in a display area of the display 16, that is, the output image displayed on the display 16. Pᵣ represents coordinates of an arbitrary pixel of the output image displayed on the display 16 at a time of end of drawing, and can be expressed as Pᵣ=(xᵣ, yᵣ). In a case where, for example, an upper left end of the display area of the display 16 is an origin (0, 0), a value of x increases rightward, and a value of y increases downward.

P_{d} represents coordinates of a pixel in the output image that is being displayed (scanned) on the display 16. In a case where the display 16 is the scan type display, since pixels emit light in order from the top pixel, the coordinates P_{d} can be expressed by following equation 1. In equation 1, k represents what frame of a video including a plurality of frame images an output image corresponds to.

$${P}_{d} = {t}_{d} [ k ] + Δ {t}_{d} [ {x}_{d} , {y}_{d} ] \qquad [ Math . 1 ]$$

### 1-3. Distortion Correction Processing

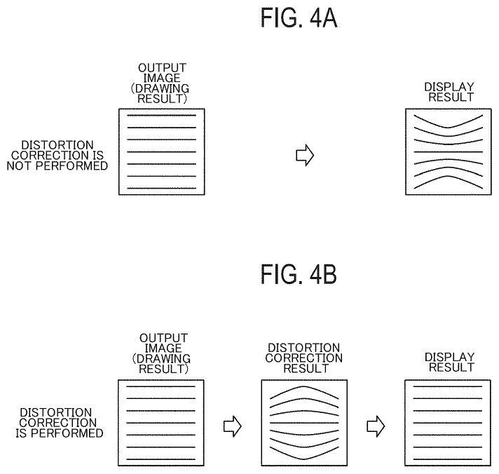

Next, distortion of the display 16 and the distortion correction processing that is the deformation processing will be described with reference to FIG. 4. For convenience of description, the output image is an image obtained by drawing a plurality of straight lines extending in a horizontal direction.

When the display 16 has distortion, and when an output image that is a drawing result of the drawing unit 13 is displayed as is on the display 16 as illustrated in FIG. 4A, a display result is distorted due to an influence of the distortion of the display 16, and the output image and the display result do not become identical. In the example in FIG. 4A, the plurality of straight lines in the output image are distorted in the display result, and the output image and the display result are not identical.

To solve this problem, distortion correction processing is performed in advance on the output image that is the drawing result as illustrated in FIG. 4B to apply distortion opposite to the distortion of the display 16. Furthermore, the display result becomes the same state as that of the original output image by displaying this distortion correction result on the display 16, so that the user can see the original state of the output image without the distortion.

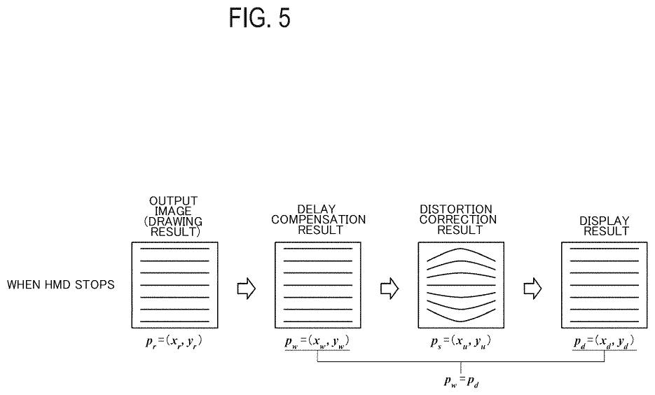

The same applies to a case where deformation processing that is delay compensation processing is performed on the output image. First, a case will be considered with reference to FIG. 5 where, when the user equipped with the HMD 10 is not moving (stops), a delay compensation result that is a result obtained by performing the delay compensation processing on the output image is displayed in a state without distortion on the display 16.

When the user equipped with the HMD 10 is not moving, since a deformation amount of image deformation that is the delay compensation processing is 0, there is no difference between the output image and the delay compensation result. Hence, as illustrated in FIG. 5, by performing the delay compensation processing on the output image, the coordinates Pᵣ=(xᵣ, yᵣ) in the output image do not change, and coordinates P_{W}=(x_{W}, y_{W}) holds in the delay compensation result.

Furthermore, when the distortion correction processing is performed on the delay compensation result, the coordinates P_{W} in the delay compensation result become coordinates Pᵤ=(xᵤ, yᵤ) in the distortion correction result. Furthermore, when this distortion correction result is displayed on the display 16, since the distortion correction processing is performed on the delay compensation result, the coordinates P_{d}=(x_{d}, y_{d}) in the display result become identical to the coordinates P_{W} in the delay compensation result, and the display 16 displays straight lines that are not distorted similarly to the delay compensation result.

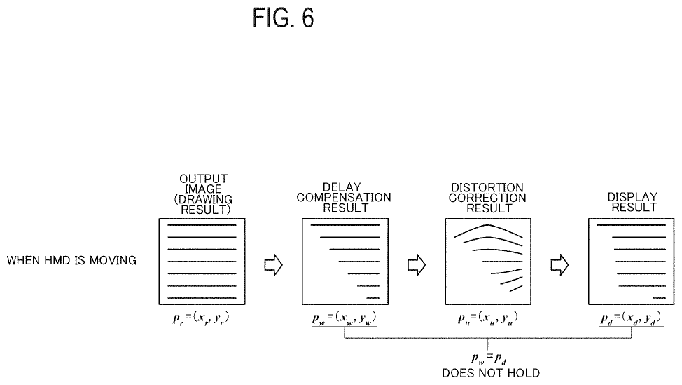

Next, a case will be considered with reference to FIG. 6 where, when the user equipped with the HMD 10 moves, a delay compensation result that is a result obtained by performing delay compensation processing on an output image is displayed in a state without distortion on the display 16.

As illustrated in FIG. 6, when the delay compensation processing is performed on the output image, the coordinates Pᵣ=(xᵣ, yᵣ) in the output image become the coordinates P_{W}=(x_{W}, y_{W}) in the delay compensation result. When the user moves, the delay compensation result is deformed by the delay compensation processing to a state different from that of the output image to compensate for a shift of this movement.

Furthermore, when the distortion correction processing is performed on the delay compensation result, the coordinates P_{W} in the delay compensation result become the coordinates Pᵤ in the distortion correction result. Furthermore, there is a problem that, when the distortion correction result is displayed on the display 16, and when distortion of the display 16 is great, even if distortion correction processing is performed on the delay compensation result, the coordinates P_{W} in the delay compensation result and the coordinates P_{d} in the display result do not become identical, and the output image is displayed in a different state from that of the delay compensation result on the display 16.

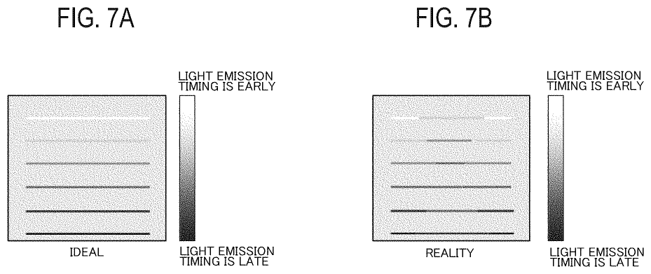

Hereinafter, distortion of the display 16 and light emission timings of pixels of the display 16 will be described with reference to FIG. 7. FIG. 7 illustrates light emission timings of pixels of the display 16 based on densities of lines.

In a case of the scan type display, it is expected as illustrated in FIG. 7A that the pixels ideally emit light in order from an upper scan line to a lower scan line. However, when the display 16 has distortion, even pixels that are seemingly neighboring on the same scan line as illustrated in FIG. 7B do not necessarily emit light in order. When the user is moving due to an actual difference of light emission timings of pixels from expected timings, an expected display result is not obtained. More specifically, when a drawing result is vertical straight lines, and when the user sees the straight lines while shaking the neck to the left and the right, the straight lines are not straight, and are seen as curved lines waving to the left and the right.

### 1-4. Processing in HMD 10 and Information Processing Device 100

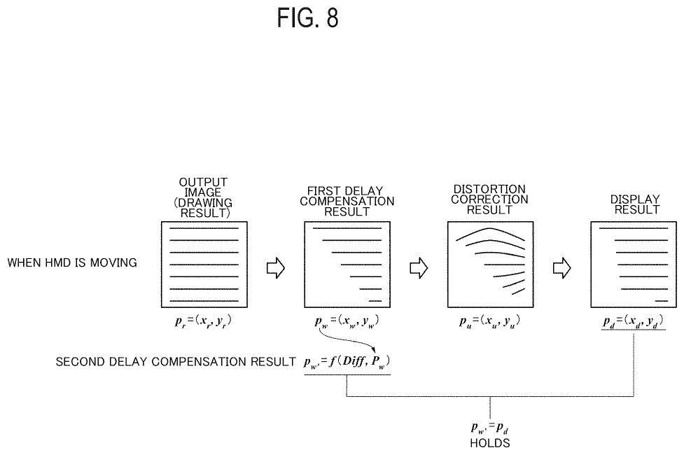

Next, processing in the HMD 10 and the information processing device 100 according to the first embodiment will be described. As described above, the problem is that the coordinates P_{W} in the delay compensation result and the coordinates P_{d} in the display result do not become identical, and therefore the delay compensation result is converted such that the delay compensation result becomes identical to the display result as illustrated in FIG. 8 in the first embodiment. An original delay compensation result will be referred to as a first delay compensation result, and a converted delay compensation result will be referred to as a second delay compensation result.

By converting the first delay compensation result into the second delay compensation result, the coordinates P_{W} in the first delay compensation result is converted into P_{W}′ in the second delay compensation result. Furthermore, when distortion correction processing is performed on the second delay compensation result using the distortion correction map, the distortion correction result is displayed on the display 16, the coordinates P_{W}′ in the second delay compensation result and the coordinates P_{d} in the display result become identical.

The light emission time correction map is used to convert the first delay compensation result into the second delay compensation result. The light emission time correction map can be created from a setting value or a calibration result of the distortion of the display 16, and a light emission time setting value of the display 16.

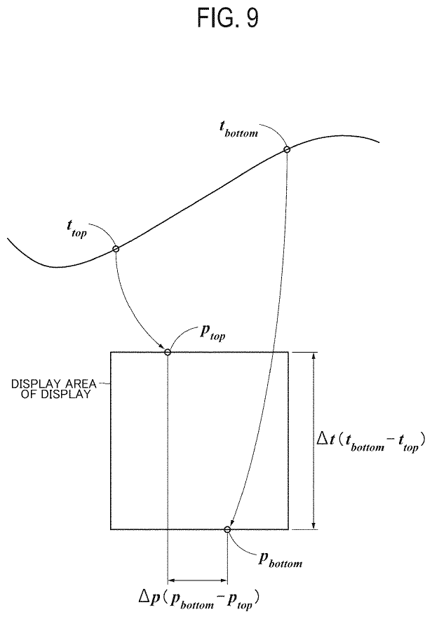

Details of the light emission time correction map will be described with reference to FIG. 9. First, a change velocity v of the own position/posture between a first position on the display area of the display 16 at a first time, and a second position on the display area of the display 16 at a second time is calculated.

In FIG. 9, the change velocity v of the own position/posture between a first position Pₜₒₚ (an upper end of the display area of the display 16) at a first time tₜₒₚ and a second position P_{bottom} (a lower end of the display area of the display 16) at a second time t_{bottom} is calculated according to following equation 2.

$$v = Δ P ( {P}_{bottom} - {P}_{top} ) / Δ t ( {t}_{bottom} - {t}_{top} ) \qquad [ Math . 2 ]$$

Note that two points in the display area of the display 16 for calculating the change velocity v of the own position/posture may be arbitrary two points. Furthermore, the second position at the second time may be the latest own position at this point of time, or the second position may be a predicted value at the point of the first time.

Next, assuming that an ideal light emission start time t_{d}+Δt of pixels constituting a frame image (the output image subjected to the distortion correction processing by the output image deformation unit 14) in the display 16 is tᵢ, and an actual light emission start time is tₐ, a coefficient Coef satisfying following equation 3 is calculated according to following equation 4.

$${P}_{w}^{′} = v \cdot {t}_{i} \cdot Coef \qquad [ Math . 3 ]$$

$$Coef = {t}_{i} / {t}_{a} \qquad [ Math . 4 ]$$

This coefficient Coef is calculated for each pixel constituting a frame image, and a map obtained by recording the coefficient Coef of each pixel as a map is the light emission time correction map. The light emission time correction map may be created in advance, for example, at a time of manufacturing of the HMD 10 or before use of the HMD 10, and is stored in the storage unit 15.

Although the coefficient Coef has a difference between the ideal light emission start time and the actual light emission start time of pixels caused by the distortion of the display 16, the light emission time correction map is information related to the distortion of the display 16. The output image deformation unit 14 converts the first delay compensation result into the second delay compensation result using the light emission time correction map. A feature of the first embodiment is that the conversion processing of the delay compensation result is performed on the output image using this light emission time correction map. When the first delay compensation result is converted into the second delay compensation result, the coordinates P_{W}′ in the second delay compensation result can be expressed as P_{W}′=f(Diff, P_{W}) using the coordinates P_{W}=(x_{W}, y_{W}) in the first delay compensation result.

The distortion correction map is used to apply opposite distortion to the second delay compensation result for distortion correction. Although a design value of a display system may be used as the distortion correction map, it may be possible to obtain a more accurate value by performing display calibration of measuring the distortion of the display 16 included in the HMD 10.

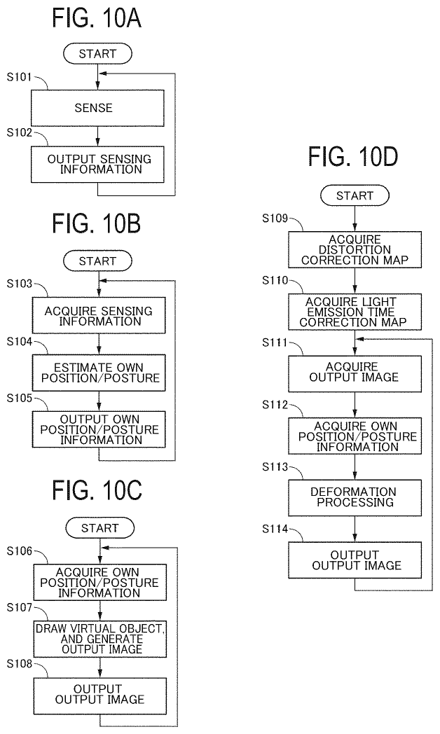

Next, the processing in the HMD 10 and the information processing device 100 will be described with reference to FIG. 10. Note that processing performed by the sensor unit 11, the own position/posture estimation unit 12, the drawing unit 13, and the output image deformation unit 14 are generally executed in an asynchronous manner, and the cycle of the processing is also usually different, and therefore the flowcharts are separated and illustrated per part. FIG. 10A illustrates the processing of the sensor unit 11, FIG. 10B illustrates the processing of the own position/posture estimation unit 12, FIG. 10C illustrates the processing of the drawing unit 13, and FIG. 10D illustrates the processing of the output image deformation unit 14. In the following description, an output image output as a drawing result by the drawing unit 13 will be described as an output image (drawing result), and a result obtained by performing deformation processing on an output image (drawing result) by the output image deformation unit 14 will be described as an output image (deformation result).

First, in step S101, the sensor unit 11 performs sensing. Furthermore, in step S102, the sensor unit 11 outputs sensing information to the own position/posture estimation unit 12. The sensor unit 11 repeatedly executes this processing at a predetermined cycle.

Next, in step S103, the own position/posture estimation unit 12 acquires the sensing information output by the sensor unit 11. Next, in step S104, the own position/posture estimation unit 12 estimates an own position/posture of the HMD 10 using the sensing information. Furthermore, in step S105, the own position/posture estimation unit 12 outputs own position/posture information to the drawing unit 13 and the output image deformation unit 14. The own position/posture estimation unit 12 repeatedly executes this processing at a predetermined cycle.

Next, in step S106, the drawing unit 13 acquires the own position/posture information that is the temporally newest at this point of time and is output by the own position/posture estimation unit 12. Next, in step S107, the drawing unit 13 draws a virtual object based on the acquired own position/posture information, and generates an output image (drawing result). Furthermore, in step S108, the drawing unit 13 outputs the output image (drawing result) to the output image deformation unit 14. The drawing unit 13 repeatedly executes step S106 to step S108 at a predetermined cycle.

Next, in step S109, the output image deformation unit 14 acquires the distortion correction map from the storage unit 15. In a case where the HMD 10 has a communication function, the output image deformation unit 14 may acquire the distortion correction map via the network.

Next, in step S110, the output image deformation unit 14 acquires the light emission time correction map from the storage unit 15. In the case where the HMD 10 has the communication function, the output image deformation unit 14 may acquire the light emission time correction map via the network. Note that step S100 and step S110 may be performed in reverse order or may be performed simultaneously or substantially simultaneously.

Next, in step S111, the output image deformation unit 14 acquires an output image (drawing result) that is the latest drawing result output from the drawing unit 13.

Next, in step S112, the output image deformation unit 14 acquires the own position/posture information that is the latest at this point of time and is output by the own position/posture estimation unit 12, and own position/posture information that is obtained at a time at which the drawing unit 13 has performed drawing. Note that step S111 and step S112 may be performed in reverse order or may be performed simultaneously or substantially simultaneously.

Next, in step S113, the output image deformation unit 14 performs deformation processing on the output image (drawing result) using the latest own position/posture information that is acquired in step S112 and the own position/posture information that is obtained at the time at which the drawing unit 13 has performed drawing and is acquired in step S112, the light emission time correction map, and the distortion correction map. As described with reference to FIG. 8, according to this deformation processing, using the light emission time correction map, conversion processing of a delay compensation result is performed on the first delay compensation result that is a result obtained by performing the delay compensation processing on the output image (drawing result). Furthermore, using the distortion correction map, distortion correction processing is performed on the second delay compensation result that is a result of the conversion processing of the delay compensation result.

Furthermore, in step S114, the output image deformation unit 14 outputs a distortion correction result as an output image (deformation result) to the display 16. The output image deformation unit 14 cyclically repeats the processing in step S109 to step S113.

Furthermore, the output image (deformation result) is displayed on the display 16. As illustrated in FIG. 8, the coordinates P_{W}′ in the second delay compensation result becomes identical to the coordinates P_{d} in the display result.

As described above, the processing in the first embodiment is performed. According to the first embodiment, even when distortion of the display 16 is great, it is possible to display the output image in a state without the distortion on the display 16 by converting the output image (drawing result) into an output image (deformation result). Consequently, even when the user equipped with the HMD 10 moves or moves the head, and the own position/posture of the HMD 10 changes, it is possible to reduce the sense of discomfort of a video that the user sees. Furthermore, it is also possible to suppress the user equipped with the HMD 10 from feeling sick. Furthermore, even when an update rate of a video is low, the video hardly breaks down, so that it is possible to lower the update rate of the video, reduce power consumption of the HMD 10, and display the video even on an HMD having a low specification. Furthermore, displays having great distortion can be adopted as displays for HMDs.

The first embodiment is applicable to a VR HMD, a VR (MR) HMD having a Video See Through (VST) function, and an optical see through AR (MR. VST is a function of providing a camera to an HMD and displaying on a display of the HMD an image of an outer world photographed by the camera. Although, when a user is equipped with an HMD, the visual field is blocked by a display or a housing, and the user cannot generally see a situation of the outside, the user can see the situation of the outside even in a state where the user is equipped with the HMD by projecting the image of the outer world photographed by a camera on the display included in the HMD.

### 2. Second Embodiment

### 2-1. Shutter System of Camera and Distortion Correction Processing

Next, a second embodiment according to the present technology will be described. The present technology is also applicable to a problem that occurs at a time of correction of an image captured by a camera of a rolling shutter system equipped with a lens having great distortion.

There are the global shutter system and the rolling shutter system for image sensors of cameras. The global shutter system is a system that reads a pixel value of each pixel after exposing all pixels of an image sensor at the same timing. On the other hand, the rolling shutter system is a system that performs exposure immediately before sequentially reading a pixel value of each pixel of an image sensor, and exposure timings vary depending on a pixel position in an image.

The rolling shutter system causes distortion due to a difference in a read-out timing of a pixel at a time of photographing of a moving object, yet is generally inexpensive compared to the global shutter system, and therefore is widely adopted not only for commercially available cameras and smartphones, but also for HMD cameras having the VST function. Furthermore, an HMD having the VST function receives data with certain delay, and therefore also has an advantage that it is possible to minimize the delay itself by synchronizing the delay and scanning of a display.

A problem in a case where a camera including an image sensor of the rolling shutter system is adopted for a Mixed Reality (MR) HMD as a camera for photographing the real world will be described. In a case where a camera including an image sensor of the rolling shutter system is adopted for an MR HMD, rolling shutter distortion occurs in an image that is an imaging result of the camera as a user moves. Although rolling shutter distortion can be corrected using own position/posture information, if distortion of a lens of the camera is great, execution of lens distortion correction does not result in an ideal read-out timing of pixels.

Hereinafter, a case will be considered where, when a user equipped with the MR HMD moves, rolling shutter distortion correction processing is performed on an input image that is the imaging result of the camera including the image sensor of the rolling shutter system, and a rolling shutter distortion correction result is displayed in a state without the distortion on a display.

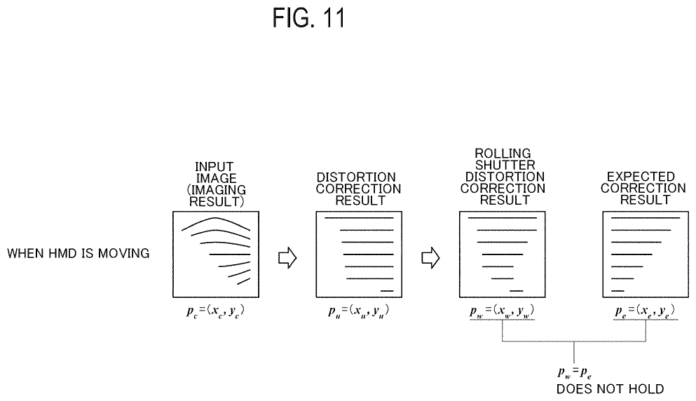

As illustrated in FIG. 11, when the distortion correction processing is performed on an input image first, coordinates P_{c}=(x_{c}, y_{c}) in the input image become the coordinates Pᵤ=(xᵤ, yᵤ) in the distortion correction result.

Furthermore, when the rolling shutter distortion correction processing is performed on the distortion correction result, the coordinates Pᵤ in the distortion compensation result become the coordinates P_{W} in a rolling shutter distortion correction result. Furthermore, there is a problem that, when distortion of the lens of the camera is great, the rolling shutter distortion correction result is not obtained as an expected correction result, and the coordinates P_{W}=(x_{W}, y_{W}) in the rolling shutter distortion correction result and coordinates Pₑ=(xₑ, yₑ) in the expected correction result do not become identical. When, for example, the own position/posture of the head of the user equipped with the HMD 10 changes from a spot A to a spot B, and movement of this change is fast, rolling distortion occurs. In this case, it can be said that the expected correction result is equal to an image captured in a state where the HMD 10 stops at the spot B.

### 2-2. Configurations of HMD 10 And Information Processing Device 100

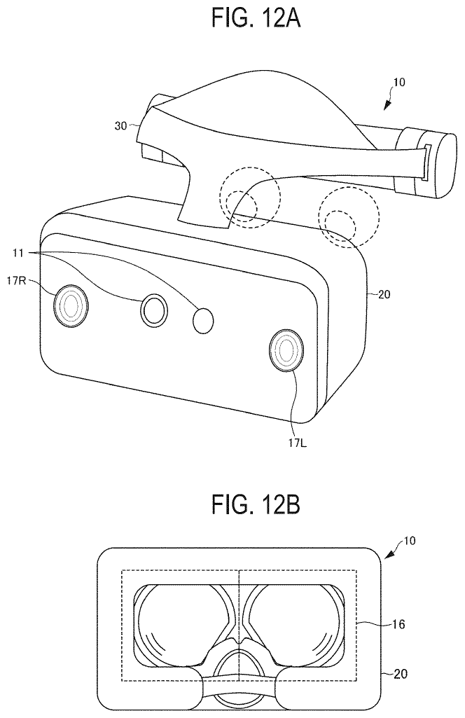

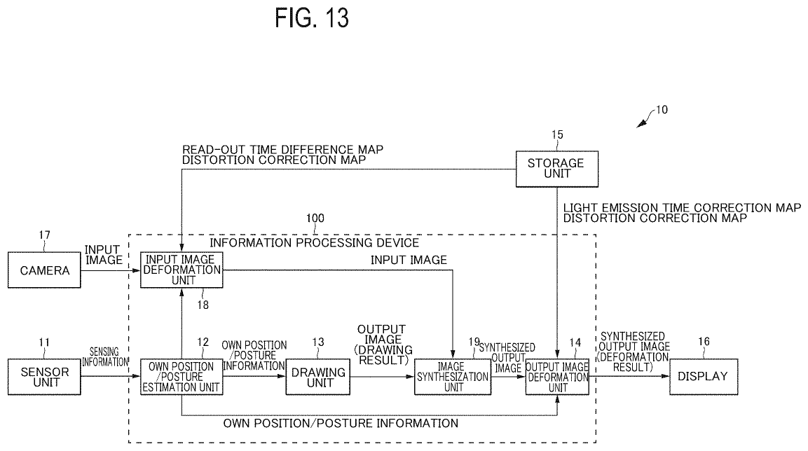

Next, the configurations of the HMD 10 and the information processing device 100 according to the second embodiment will be described with reference to FIGS. 12 and 13. The second embodiment differs from the first embodiment in including a camera 17, an input image deformation unit 18, and an image synthesization unit 19. The other components are the same as those in the first embodiment, and therefore description thereof will be omitted.

The camera 17 photographs the real world, and outputs an input image that is a imaging result. The camera 17 is a camera that includes an image sensor of the rolling shutter system, a signal processing circuit, and the like, and can capture color images of Red, Green, and Blue (RGB) or a single color and color videos. The present embodiment assumes that the lens is a wide angle lens like a fisheye lens having great distortion. The camera 17 includes a left camera 17L that captures a left-eye image, and a right camera 17R that captures a right-eye image. The left camera 17L and the right camera 17R are directed to a visual line direction of the user and provided outside the housing 20 of the HMD 10, and photographs the real world in the visual line direction of the user. In a case where the left camera 17L and the right camera 17R do not need to be distinguished in the following description, the left camera 17L and the right camera 17R will be referred to simply as the camera 17. In this regard, the HMD 10 includes the one camera 17, and may clip one imaging result of the one camera 17 for a left-eye area image and a right-eye area image.

The input image deformation unit 18 performs deformation processing on the input image that is the imaging result of the camera 17 based on the read-out time difference map, the distortion correction map, and latest own position/posture information output by the own position/posture estimation unit 12. The deformation processing includes distortion correction processing, rolling shutter distortion correction processing, and conversion processing of a rolling shutter distortion correction result.

The distortion correction processing is processing of applying, to an input image, distortion opposite to distortion of the lens of the camera 17. Conversion processing in the input image deformation unit 18 may be performed by a general-purpose processor such as a GPU, or a dedicated circuit.

Rolling shutter distortion correction processing is processing of deforming an input image to correct rolling shutter distortion.

Conversion processing of a rolling shutter distortion correction result is processing of converting a rolling shutter distortion correction result for making the rolling shutter distortion correction result and an expected correction result identical even when the distortion of the lens of the camera 17 is great.

The image synthesization unit 19 synthesizes the input image output from the input image deformation unit 18 and the output image output from the drawing unit 13, and generates a synthesized output image.

Note that, in the second embodiment, the own position/posture estimation unit 12 outputs own position/posture information that is an estimation result to the drawing unit 13, the output image deformation unit 14, and the input image deformation unit 18.

In the second embodiment, the information processing device 100 includes the own position/posture estimation unit 12, the input image deformation unit 18, the drawing unit 13, and the output image deformation unit 14. Similarly to the first embodiment, the information processing device 100 may operate in the HMD 10, or may operate in an external electronic device connected with the HMD 10, or, by executing a program, the information processing device 100 and the information processing method may be implemented.

### 2-3. Processing in HMD 10 and Information Processing Device 100

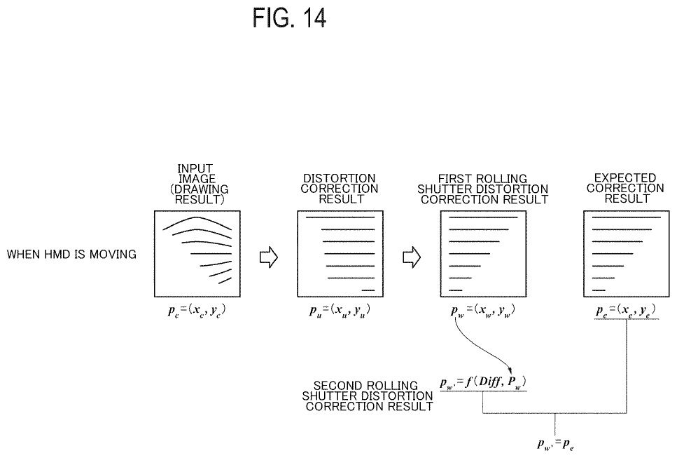

Next, processing in the HMD 10 and the information processing device 100 according to the second embodiment will be described. As described above, the problem is that the coordinates P_{W} in the rolling shutter distortion correction result and the coordinates Pₑ in the expected correction result do not become identical, and therefore, in the second embodiment, conversion processing is performed on the rolling shutter distortion correction result such that the rolling shutter distortion correction result becomes identical to the expected correction result as illustrated in FIG. 14. An original rolling shutter distortion correction result will be referred to as a first rolling shutter distortion correction result, and a new rolling shutter distortion correction result will be referred to as a second rolling shutter distortion correction result. Furthermore, the coordinates P_{W}′ in the second rolling shutter distortion correction result and the coordinates Pₑ in the expected correction result become identical.

Assuming that an ideal condensation start time t_{C}+Δt of pixels constituting a frame image is tᵢ, and an actual condensation start time is tₐ, the coefficient Coef satisfying following equation 5 is calculated according to following equation 6. v represents the change velocity v of the own position/posture that can be calculated according to equation 2 in the first embodiment.

$${P}_{W}^{′} = v \cdot {t}_{i} \cdot Coef \qquad [ Math . 5 ]$$

$$Coef = {t}_{i} / {t}_{a} \qquad [ Math . 6 ]$$

This coefficient Coef is calculated for each pixel constituting a frame image, and a map obtained by recording the coefficient Coef of each pixel as a map is the read-out time difference map. The read-out time difference map may be created in advance, for example, at a time of manufacturing of the HMD 10 or before use of the HMD 10, and is stored in the storage unit 15.

Although the coefficient Coef has a difference between the ideal condensation start time and the actual condensation start time of pixels caused by the distortion of the camera 17, the read-out time difference map is information related to the distortion of the lens of the camera 17. The input image deformation unit 18 performs conversion processing on the rolling shutter distortion correction result using the read-out time difference map, and converts the first rolling shutter distortion correction result into the second rolling shutter distortion correction result. A feature of the second embodiment is that the conversion processing of the rolling shutter distortion correction result is performed on the input image using this read-out time difference map. When the first rolling shutter distortion correction result is converted into the second rolling shutter distortion correction result, the coordinates P_{W}′ in the second rolling shutter distortion correction result can be expressed as P_{W}′=f(Diff, P_{W}) using the coordinates P_{W}=(x_{W}, y_{W}) in the first rolling shutter distortion correction result.

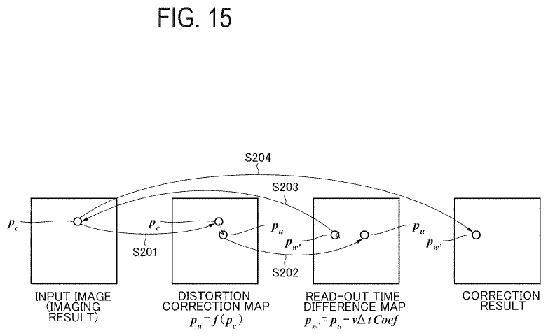

Hereinafter, the deformation processing of deforming the input image into the second rolling shutter distortion correction result using the read-out time difference map will be described with reference to FIG. 15.

First, in step S201, the input image deformation unit 18 refers to coordinates P_{c} on the distortion correction map corresponding to the arbitrary coordinate P_{c} of the input image that is an imaging result, and obtains the coordinates Pᵤ after distortion correction. The coordinates Pᵤ can be expressed as in equation 7.

$${P}_{u} = f ( {P}_{c} ) \qquad [ Math . 7 ]$$

Next, in step S202, the input image deformation unit 18 refers to the coordinates Pᵤ in the read-out time difference map, and obtains the coefficient Coef.

Furthermore, the input image deformation unit 18 calculates the coordinates P_{W}′ according to following equation 8 using the change velocity v of the own position/posture, a time difference Δt, the coefficient Coef, and the coordinates Pᵤ. The change velocity v of the own position/posture is similar to that in the first embodiment.

$${P}_{w}^{′} = {p}_{u} \cdot v \cdot Δ t \cdot Coef \qquad [ Math . 8 ]$$

Next, in step S203, the input image deformation unit 18 extracts from the input image a pixel of the coordinate P_{c} corresponding to the position of the coordinates P_{W}′.

Furthermore, in step S204, the input image deformation unit 18 draws the pixel of the coordinate P_{c} extracted from the input image, to the position of the coordinates P_{W}′ as a correction result. Thus, it is possible to deform the input image into the first rolling shutter distortion correction result, and convert the first rolling shutter distortion correction result into the second rolling shutter distortion correction result.

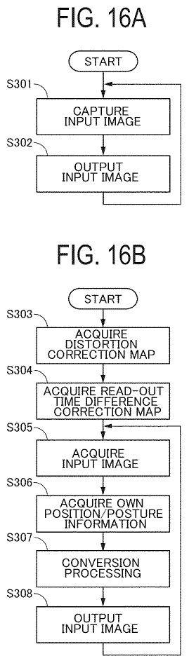

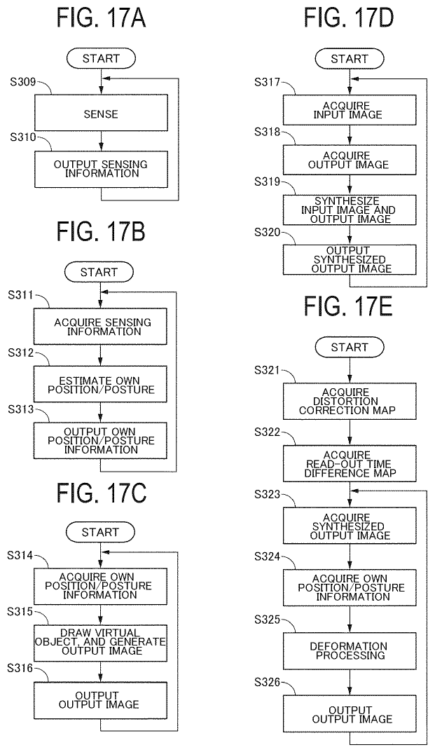

Next, the processing in the HMD 10 and the information processing device 100 according to the second embodiment will be described with reference to FIGS. 16 and 17. Note that processing performed by the camera 17, the input image deformation unit 18, the sensor unit 11, the own position/posture estimation unit 12, the drawing unit 13, the image synthesization unit 19, and the output image deformation unit 14 are generally executed in an asynchronous manner, and the cycle of the processing is also usually different, and therefore the flowcharts are separated and illustrated per part. FIG. 16A illustrates processing of the camera 17, and FIG. 16B illustrates processing of the input image deformation unit 18. Furthermore, FIG. 17A illustrates the processing of the sensor unit 11, FIG. 17B illustrates the processing of the own position/posture estimation unit 12, FIG. 17C illustrates the processing of the drawing unit 13, FIG. 17D illustrates the processing of the image synthesization unit 19, and FIG. 17E illustrates the processing of the output image deformation unit 14. In the following description, an output image output as a drawing result by the drawing unit 13 will be described as an output image (drawing result), and a synthesized output image output as a deformation result by the output image deformation unit 14 will be described as a synthesized output image (deformation result).

First, in step S301, the camera 17 photographs the real world. Furthermore, in step S302, the camera 17 outputs to the input image deformation unit 18 the input image that is the imaging result obtained by photographing. The input image is a frame image constituting a video see through video corresponding to one frame.

Next, in step S303, the input image deformation unit 18 acquires the distortion correction map from the storage unit 15. In the case where the HMD 10 has the communication function, the input image deformation unit 18 may acquire the distortion correction map via the network.

Next, in step S304, the input image deformation unit 18 acquires the read-out time difference map from the storage unit 15. In the case where the HMD 10 has the communication function, the input image deformation unit 18 may acquire the read-out time difference map via the network. Note that step S303 and step S304 may be performed in reverse order or may be performed simultaneously or substantially simultaneously.

Next, in step S305, the input image deformation unit 18 acquires the input image that is the imaging result output from the camera 17.

Next, in step S306, the input image deformation unit 18 acquires the own position/posture information that is the temporally newest at this point of time and is output by the own position/posture estimation unit 12, and an own position/posture estimation result at a point of time of imaging.

Next, in step S307, the input image deformation unit 18 performs conversion processing on the input image using the temporally newest own position/posture information, the own position/posture estimation result obtained at the point of time of imaging, the read-out time difference map, and the distortion correction map. As described with reference to FIGS. 14 and 15, according to this conversion processing, rolling shutter distortion correction is performed on a distortion correction result that is a result obtained by performing distortion correction on the input image using the distortion correction map. Furthermore, the first rolling shutter distortion correction result is converted into the second rolling shutter distortion correction result by using the read-out time difference map.

Furthermore, in step S308, the input image deformation unit 18 outputs the input image that is the second rolling shutter distortion correction result to the image synthesization unit 19.

First, in step S309, the sensor unit 11 performs sensing. Furthermore, in step S310, the sensor unit 11 outputs the sensing information to the own position/posture estimation unit 12. The sensor unit 11 repeatedly executes this processing at the predetermined cycle.

Next, in step S311, the own position/posture estimation unit 12 acquires the sensing information output by the sensor unit 11. Next, in step S312, the own position/posture estimation unit 12 estimates the own position/posture of the HMD 10 using the sensing information. Furthermore, in step S313, the own position/posture estimation unit 12 outputs the own position/posture information to the input image deformation unit 18, the drawing unit 13, and the output image deformation unit 14. The own position/posture estimation unit 12 repeatedly executes this processing at the predetermined cycle.

Next, in step S314, the drawing unit 13 acquires the own position/posture information that is the temporally newest at this point of time and is output by the own position/posture estimation unit 12.

Next, in step S315, the drawing unit 13 draws a virtual object based on the acquired own position/posture information, and generates an output image (drawing result). Furthermore, in step S316, the drawing unit 13 outputs the output image (drawing result) to the image synthesization unit 19. The drawing unit 13 repeatedly executes step S314 to step S316 at the predetermined cycle.

Note that outputting the input image in step S308 does not necessarily need to be completed before the output image (drawing result) is output in step S316, and outputting the output image (drawing result) may be completed first or completed at the same time or substantially the same time as outputting of the input image.

Next, in step S317, the image synthesization unit 19 acquires the input image output by the input image deformation unit 18. Next, in step S318, the image synthesization unit 19 acquires the output image (drawing result) output by the drawing unit 13.

Furthermore, in step S319, the image synthesization unit 19 synthesizes the output image (drawing result) with the input image, and generates a synthesized output image. Consequently, the virtual object drawn in the output image (drawing result) is synthesized with the input image that is an image obtained by photographing the real world.

Furthermore, in step S320, the image synthesization unit 19 outputs the synthesized output image to the output image deformation unit 14.

Note that the image synthesization unit 19 may not be provided, and the output image deformation unit 14 may synthesize the input image and the output image (drawing result).

Next, in step S321, the output image deformation unit 14 acquires the distortion correction map from the storage unit 15. In the case where the HMD 10 has the communication function, the output image deformation unit 14 may acquire the distortion correction map via the network.

Next, in step S322, the output image deformation unit 14 acquires the read-out time difference map from the storage unit 15. In the case where the HMD 10 has the communication function, the output image deformation unit 14 may acquire the read-out time difference map via the network. Note that step S321 and step S322 may be performed in reverse order or may be performed simultaneously or substantially simultaneously.

Next, in step S323, the output image deformation unit 14 acquires the synthesized output image output by the image synthesization unit 19.

Next, in step S324, the output image deformation unit 14 acquires the own position/posture information that is the latest at this point of time and is output by the own position/posture estimation unit 12, and own position/posture information that is obtained at a time at which the drawing unit 13 has performed drawing. Note that step S323 and step S324 may be performed in reverse order or may be performed simultaneously or substantially simultaneously.

Next, in step S325, the output image deformation unit 14 performs deformation processing on the synthesized output image using the latest own position/posture information acquired in step S324, the own position/posture information that is obtained at the time at which the drawing unit 13 has performed drawing, the read-out time difference map, and the distortion correction map. The deformation processing performed by the output image deformation unit 14 is the same as the processing performed on the output image (drawing result) by the output image deformation unit 14 in the first embodiment.

Furthermore, in step S326, the output image deformation unit 14 outputs a distortion correction result as the synthesized output image (deformation result) to the display 16. The output image deformation unit 14 cyclically repeats the processing in step S323 to step S326.

Furthermore, the synthesized output image (deformation result) is displayed on the display 16.

As described above, the processing in the second embodiment is performed. According to the second embodiment, even when the distortion of the lens of the camera 17 is great, it is possible to display an image in a state without the distortion on the display 16. Consequently, even when the user equipped with the HMD 10 moves or moves the head, it is possible to reduce the sense of discomfort of a video that the user sees. Furthermore, it is also possible to suppress the user equipped with the HMD 10 from feeling sick. Furthermore, even when an update rate of a video see through video is low, the video hardly breaks down, so that it is possible to lower the update rate of the video, reduce power consumption of the HMD 10, and display the video even on the HMD 10 having a low specification. Furthermore, cameras with lenses having great distortion can be adopted as cameras for the HMD 10.

### 3. Modification

The embodiments of the present technology have been described specifically, but the present technology is not limited to the above-described embodiments and various modifications can be made based on the technical spirit and essence of the present technology.

Although the embodiments have been described citing the example where the device is the HMD 10, the present technology is applicable to smartphones and tablet terminals as long as devices include cameras including distorted displays or distorted lenses.

Although the HMD 10 includes both of the output image deformation unit 14 and the input image deformation unit 18 in the above-described second embodiment, the HMD 10 may include the input image deformation unit 18 without including the output image deformation unit 14.

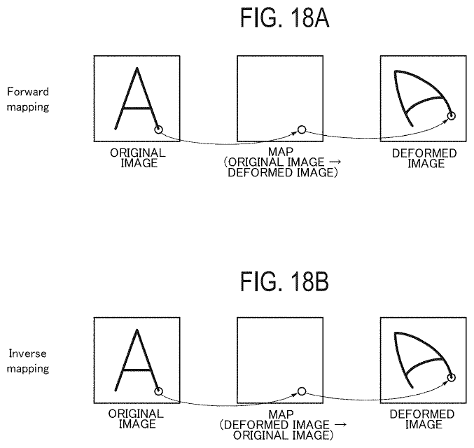

Next, a modification of processing in the output image deformation unit 14 will be described. There are two types of expressions of a relationship between element sets constituting an image. The two types include a method (forward mapping) that indicates which position in a deformed image an element of an original image corresponds to as illustrated in FIG. 18A, and a method (inverse mapping) that indicates which position in the original image an element at a certain position in a deformed image corresponds to as illustrated in FIG. 18B.

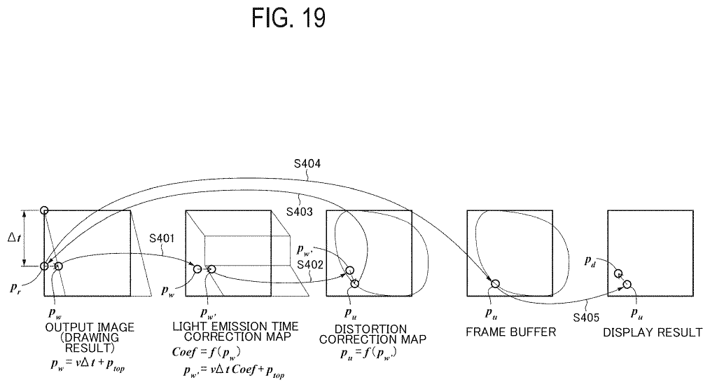

First, deformation of an output image that uses forward mapping will be described with reference to FIG. 19.

First, as indicated in step S401, the output image deformation unit 14 converts the coordinates Pᵣ into the coordinates P_{W} using the change velocity v of the own position/posture, the initial position Pₜₒₚ, the light emission time tₜₒₚ of the initial position Pₜₒₚ, and the ideal time difference Δt of the light emission time tₜₒₚ+Δt of the arbitrary coordinates Pᵣ by the method described with reference to FIG. 9.

Next, as indicated in step S402, the output image deformation unit 14 acquires the coefficient Coef of the coordinate P_{W} referring to the light emission time correction map. Furthermore, the output image deformation unit 14 calculates P_{W}′ using the change velocity v of the own position/posture, the initial position Pₜₒₚ, the time difference Δt, and the coefficient Coef.

Next, as indicated in step S403, the output image deformation unit 14 obtains the coordinates Pᵤ after distortion correction of the coordinates P_{W}′ referring to the distortion correction map, and extracts the pixel of the coordinate Pᵣ corresponding to the position of the coordinates Pᵤ from the output image.

Next, as indicated in step S404, the output image deformation unit 14 draws at the position of Pᵤ of a frame buffer the pixel of the coordinates Pᵣ extracted from the output image.

Furthermore, as indicated in step S405, when the display 16 causes the pixel of Pᵤ of the frame buffer to emit light, the light is perceived at the position of the coordinates P_{d} by the user.

As described above, it is possible to perform deformation processing of an output image that uses forward mapping.

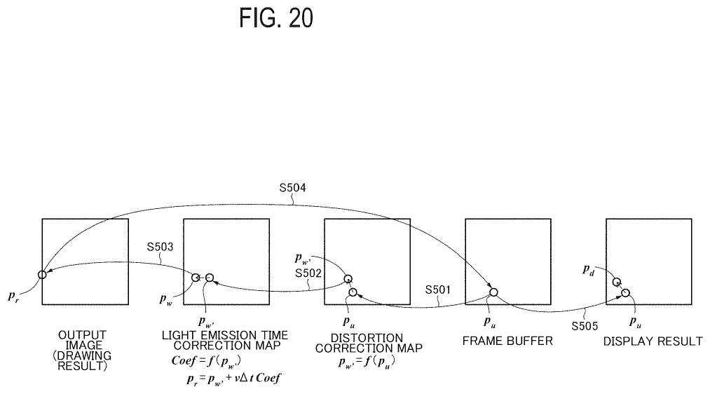

Next, deformation of an output image that uses inverse mapping will be described with reference to FIG. 20.

First, as indicated in step S501, the output image deformation unit 14 refers to the coordinates Pᵤ on the distortion correction map corresponding to the arbitrary coordinate Pᵤ of the frame buffer, and obtains the coordinates P_{W}′ of the pixel that needs to come to the coordinates Pᵤ after distortion correction.

Next, as indicated in step S502, the output image deformation unit 14 acquires the coefficient Coef of the pixel located at the coordinate P_{W}′ referring to the light emission time correction map, and calculates the coordinates Pᵣ using the change velocity v of the own position/posture, the time difference Δt, the coefficient Coef, and the coordinates P_{W}′.

Next, as indicated in step S503, the output image deformation unit 14 extracts a pixel corresponding to the coordinate Pᵣ in the output image.

Next, as indicated in step S504, the output image deformation unit 14 draws at the position of the coordinates Pᵤ of a frame buffer the pixel of the coordinates Pᵣ in the output image.

Furthermore, as indicated in step S505, when the display 16 causes the pixel of the coordinates Pᵤ of the frame buffer to emit light, the light is perceived at the position of the coordinates P_{d} by the user.

As described above, it is possible to perform deformation of an output image that uses inverse mapping.

The present technique can be also configured as follows:

(1)

The information processing device includes:
an own position/posture estimation unit that estimates a position and a posture of a device based on sensing information acquired by a sensor unit, and outputs own position/posture information; and
an image deformation unit that performs deformation processing on an image based on the own position/posture information and information related to distortion of an optical system included in the device.
   (2)

In the information processing device described in (1),
the image is an output image generated by a drawing unit by drawing a virtual object based on the own position/posture information, and
the image deformation unit is an output image deformation unit that performs the deformation processing on the output image.
   (3)

In the information processing device described in (2), the output image deformation unit performs delay compensation processing on the output image, the delay compensation processing compensating for delay of display of the output image on a display that is the optical system.

(4)

In the information processing device described in (3), the output image deformation unit performs conversion processing such that the output image subjected to the delay compensation processing is identical to a display result of the display.

(5)

In the information processing device described in (4), the conversion processing is performed based on a light emission start time of a pixel caused by the distortion of the display.

(6)

In the information processing device described in (5), the conversion processing is performed using information obtained by calculating a difference between an ideal value and a real value of the light emission start time per pixel.

(7)

In the information processing device described in any one of (2) to (6), the output image deformation unit performs distortion correction processing of applying, to the output image, distortion opposite to the distortion of the display that is the optical system.

(8)

In the information processing device described in any one of (1) to (7), the image is an input image captured by a camera that is the optical system, and the image deformation unit is an input image deformation unit that performs the deformation processing on the input image.

(9)

In the information processing device described in (8), the input image deformation unit performs rolling shutter distortion correction processing on the input image, the rolling shutter distortion correction processing correcting distortion of a lens of the camera of a rolling shutter system.

(10)

In the information processing device described in (9), the input image deformation unit performs conversion processing such that the input image subjected to the rolling shutter distortion correction processing is identical to an expected correction result.

(11)

In the information processing device described in (10), the conversion processing is performed based on a condensation start time of a pixel caused by the distortion of the lens of the camera.

(12)

In the information processing device described in (11), the conversion processing is performed using information obtained by calculating a difference between an ideal value and a real value of the condensation start time per pixel.

(13)

In the information processing device described in any one of (8) to (12), the input image deformation unit performs distortion correction processing of applying, to the input image, distortion opposite to the distortion of the lens of the camera.

(14)

The information processing device described in any one of (8) to (13) further includes an image synthesization unit that synthesizes the input image deformed by the input image deformation unit and an output image generated by a drawing unit by drawing a virtual object based on the own position/posture information, and generates a synthesized image.

(15)

The information processing device described in (14) further includes an output image deformation unit that performs the deformation processing on the synthesized image.

(16)

In the information processing device described in any one of (1) to (15), the device is a head mount display.

(17)

An information processing method includes:
estimating a position and a posture of a device based on sensing information acquired by a sensor unit, and outputting own position/posture information; and performing deformation processing on an image based on the own position/posture information and information related to distortion of an optical system included in the device.
   (18)

A program causes a computer to execute an information processing method including:
estimating a position and a posture of a device based on sensing information acquired by a sensor unit, and outputting own position/posture information; and performing deformation processing on an image based on the own position/posture information and information related to distortion of an optical system included in the device.

### REFERENCE SIGNS LIST

10 Head Mount Display (HMD)
11 Sensor unit
12 Own position/posture estimation unit
13 Drawing unit
14 Output image deformation unit
17 Camera
18 Input image deformation unit
19 Image synthesization unit
100 Information processing device

What is claimed is:

1. An information processing device comprising:
an own position/posture estimation unit that estimates a position and a posture of a device based on sensing information acquired by a sensor unit, and outputs own position/posture information; and
an image deformation unit that performs deformation processing on an image based on the own position/posture information and information related to distortion of an optical system included in the device.

2. The information processing device according to claim 1, wherein
the image is an output image generated by a drawing unit by drawing a virtual object based on the own position/posture information, and
the image deformation unit is an output image deformation unit that performs the deformation processing on the output image.

3. The information processing device according to claim 2, wherein the output image deformation unit performs delay compensation processing on the output image, the delay compensation processing compensating for delay of display of the output image on a display that is the optical system.

4. The information processing device according to claim 3, wherein the output image deformation unit performs conversion processing such that the output image subjected to the delay compensation processing is identical to a display result of the display.

5. The information processing device according to claim 4, wherein the conversion processing is performed based on a light emission start time of a pixel caused by the distortion of the display.

6. The information processing device according to claim 5, wherein the conversion processing is performed using information obtained by calculating a difference between an ideal value and a real value of the light emission start time per pixel.

7. The information processing device according to claim 2, wherein the output image deformation unit performs distortion correction processing of applying, to the output image, distortion opposite to the distortion of the display that is the optical system.

8. The information processing device according to claim 1, wherein
the image is an input image captured by a camera that is the optical system, and
the image deformation unit is an input image deformation unit that performs the deformation processing on the input image.

9. The information processing device according to claim 8, wherein the input image deformation unit performs rolling shutter distortion correction processing on the input image, the rolling shutter distortion correction processing correcting distortion of a lens of the camera of a rolling shutter system.

10. The information processing device according to claim 9, wherein the input image deformation unit performs conversion processing such that the input image subjected to the rolling shutter distortion correction processing is identical to an expected correction result.

11. The information processing device according to claim 10, wherein the conversion processing is performed based on a condensation start time of a pixel caused by the distortion of the lens of the camera.

12. The information processing device according to claim 11, wherein the conversion processing is performed using information obtained by calculating a difference between an ideal value and a real value of the condensation start time per pixel.

13. The information processing device according to claim 8, wherein the input image deformation unit performs distortion correction processing of applying, to the input image, distortion opposite to the distortion of the lens of the camera.

14. The information processing device according to claim 8, further comprising an image synthesization unit that synthesizes the input image deformed by the input image deformation unit and an output image generated by a drawing unit by drawing a virtual object based on the own position/posture information, and generates a synthesized image.

15. The information processing device according to claim 14, further comprising an output image deformation unit that performs the deformation processing on the synthesized image.

16. The information processing device according to claim 1, wherein the device is a head mount display.

17. An information processing method comprising:
estimating a position and a posture of a device based on sensing information acquired by a sensor unit, and outputting own position/posture information; and
performing deformation processing on an image based on the own position/posture information and information related to distortion of an optical system included in the device.

18. A program causing a computer to execute an information processing method comprising:
estimating a position and a posture of a device based on sensing information acquired by a sensor unit, and outputting own position/posture information; and
performing deformation processing on an image based on the own position/posture information and information related to distortion of an optical system included in the device.
